(19) United States
(12) Patent Application Publication
(10) Pub. No.: US 2026/0364963 A1
(43) Pub. Date: Nov. 19, 2026

(54) PRINTER

(71) Applicant: Toshiba Tec Kabushiki Kaisha, Tokyo (JP)

(72) Inventor: Kiyotaka NIHASHI, Mishima Shizuoka (JP)

(21) Appl. No.: 19/740,932

(22) Filed: Jul. 14, 2026

Related U.S. Application Data
(63) Continuation of application No. PCT/JP2024/042686, filed on Dec. 3, 2024.

(30) Foreign Application Priority Data
Apr. 12, 2024 (JP) 2024-064652

(51) Int. Cl. B41J 15/04; B41J 3/407; B41J 29/13

(52) U.S. Cl. CPC B41J 15/046; B41J 3/4075; B41J 15/042; B41J 15/048; B41J 29/13

(57) ABSTRACT

A printer according to an embodiment includes a main body, a conveying part, a printing part, a pressing member, a link arm, and a restricting member. The main body includes a housing portion to house a roll of a long printing medium which has been wound in a roll shape. The conveying part sends the printing medium to outside of the main body. The printing part prints information on the printing medium. The pressing member is rotatably attached to the cover via a first rotation shaft and presses the roll against an inner surface of the housing portion. The link arm is rotatably attached to the main body via a second rotation shaft parallel to the first rotation shaft, and includes a slider. The restricting member is attached to the slider and restricts movement of the roll in the direction in which the printing medium is pulled out.

### CROSS REFERENCE TO RELATED APPLICATIONS

This application is a Continuation Application of PCT Application No. PCT/JP2024/042686, filed Dec. 3, 2024 and based upon and claiming the benefit of priority from Japanese Patent Application No. 2024-064652, filed Apr. 12, 2024, the entire contents of all of which are incorporated herein by reference.

### FIELD

Embodiments described herein relate generally to a printer.

### BACKGROUND

For example, labels to be attached to packages of food in supermarkets are applied with an adhesive to a surface opposite to a printing surface, and are distributed in a state where the labels are arranged and attached to a long release paper and wound in a roll shape. There is also a label roll formed by applying a release treatment to a printing surface of a long linerless label without a release paper and winding the linerless label into a roll shape, which is environmentally friendly.

To facilitate replacement of the label roll, such printers that print information on a linerless label without a release paper adopt a so-called drop-in method in which the label roll can be loaded by simply opening a cover and inserting the label roll into a hopper of a main body.

Because the drop-in method printer does not have a shaft to rotatably support the label roll, the label roll is likely to become unstable in the hopper when the linerless label is pulled out from the roll. In order to suppress the label roll from becoming unstable as mentioned above, there is a printer including a flapper to press the label roll against an inner wall of the hopper.

In a case where a linerless label roll is inserted into the above-described conventional printer, at the time where the roll diameter is large the label roll is positioned at a bottom of the hopper due to gravity, but as the roll diameter becomes small and lighter in weight the label roll is easily moved in a direction in which the linerless label is pulled out. For example, in a case of inserting a label roll which is a roll formed by winding a linerless label coated with a weak adhesive which enables re-peeling from a surface to which the label is to be adhered, after the pulling out of the linerless label is stopped, the label roll falls to the bottom of the hopper while rotating by its own weight.

In the case where the label roll moves in the hopper in this manner, the label roll collides with the bottom of the hopper and the inner surface of the cover, and the printer vibrates. In the case where the printer vibrates, a print head may vibrate, or a conveying position of the linerless label may be displaced, which may cause a printing failure.

### BRIEF DESCRIPTION OF THE DRAWINGS

FIG. 1 is a cross-sectional view of a printer according to an embodiment.

FIG. 2 is a cross-sectional view illustrating a state in which a cover of the printer in FIG. 1 is opened.

FIG. 3 is a perspective view showing a configuration of a cover side and a paper guide of a main body side of the printer of FIG. 2.

FIG. 4 is a perspective view of the main parts of FIG. 3 as viewed from the cover side.

FIG. 5 is a partial enlarged view for explaining a link mechanism of FIG. 3.

FIG. 6 is a cross-sectional view illustrating an example of a state in which a diameter of a label roll inserted into the printer of FIG. 1 is reduced.

FIG. 7 is a cross-sectional view illustrating a state in which the label roll in FIG. 6 has moved in a pulling out direction of labels.

FIG. 8 is a cross-sectional view illustrating a state in which the label roll in FIG. 6 has moved to the bottom of a hopper.

FIG. 9 is a cross-sectional view illustrating a state in which the label roll in FIG. 8 has become small and has moved past a tip end of a flapper.

FIG. 10 is a perspective view illustrating a main part of a printer according to a modification.

### DETAILED DESCRIPTION

A printer according to an embodiment includes a main body, a cover, a conveying part, a printing part, a pressing member, a link arm, and a restricting member. The main body includes a housing portion to house a roll of a long printing medium which has been wound in a roll shape. The cover opens and closes the housing portion. The conveying part pulls out the printing medium from the roll and sends the printing medium to outside of the main body. The printing part prints information on the printing medium pulled out from the roll with the conveying part. The pressing member is rotatably attached to the cover via a first rotation shaft and presses the roll against an inner surface of the housing portion. The link arm is rotatably attached to the main body via a second rotation shaft parallel to the first rotation shaft, and includes a slider slidably inserted through and arranged in elongated holes in the pressing member. The restricting member is attached to the slider and restricts movement of the roll in the direction in which the printing medium is pulled out.

Hereinafter, an embodiment and its modification will be described with reference to the drawings. In the embodiment and its modification, the same components are denoted by the same reference signs, and redundant description will be omitted.

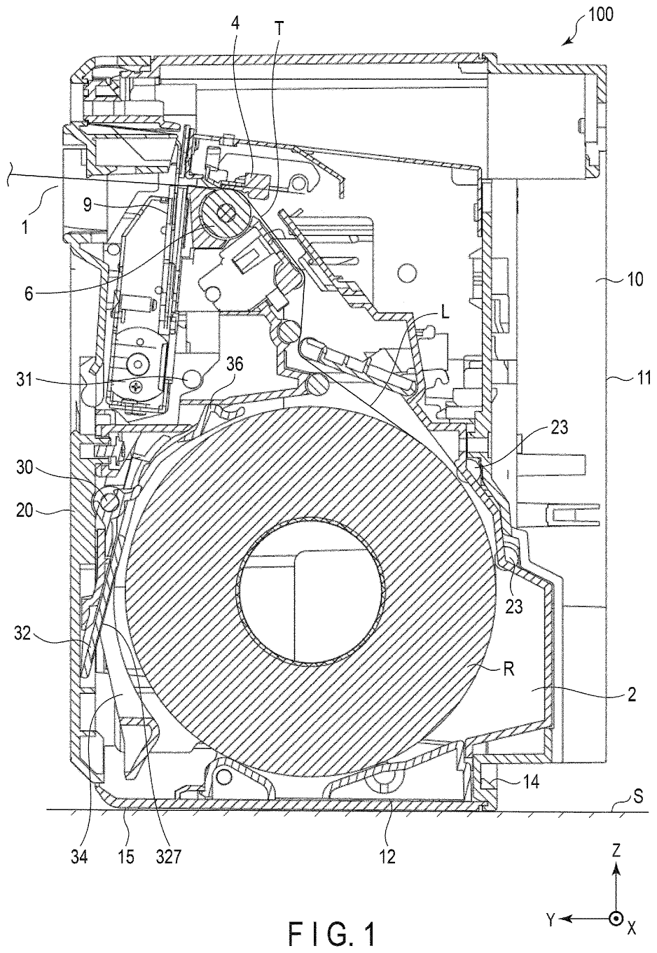

As shown in FIG. 1, a printer 100 according to the embodiment includes a main body 10 including a hopper 2 that can house a label roll R inside, and a cover 20 to open and close the hopper 2. The hopper 2 is an example of the housing unit to rotatably house the label roll R. The printer 100 has a transport path T connected from the hopper 2 between the main body 10 and the cover 20. The printer 100 has a discharge port 1 to discharge labels at the end of the transport path T to the downstream side spaced apart from the hopper 2.

The label roll R is an example of a roll which is inserted into the printer 100, and is a long strip-shaped linerless label L without a release paper wound in a roll shape. The linerless label L is an example of a printing medium and has a printing surface that will be an outer side of the roll. An adhesive is provided on a surface opposite to the printing surface. The printing surface is subjected to a release treatment for the adhesive. The adhesive may be made weakly adhesive to provide a re-peelable linerless label. The label roll R is not limited to a roll of the wound linerless label L, and may be a roll of a plurality of labels arranged and attached on a long release paper.

The label roll R is inserted into the hopper 2 in an orientation shown in FIG. 1. Therefore, at the time the linerless label L is pulled out from the label roll R, the label roll R rotates in a counterclockwise direction in FIG. 1. The printer 100 has a cutter 9 near the discharge port 1, divides the linerless label L into a plurality of labels, and discharges the labels through the discharge port 1.

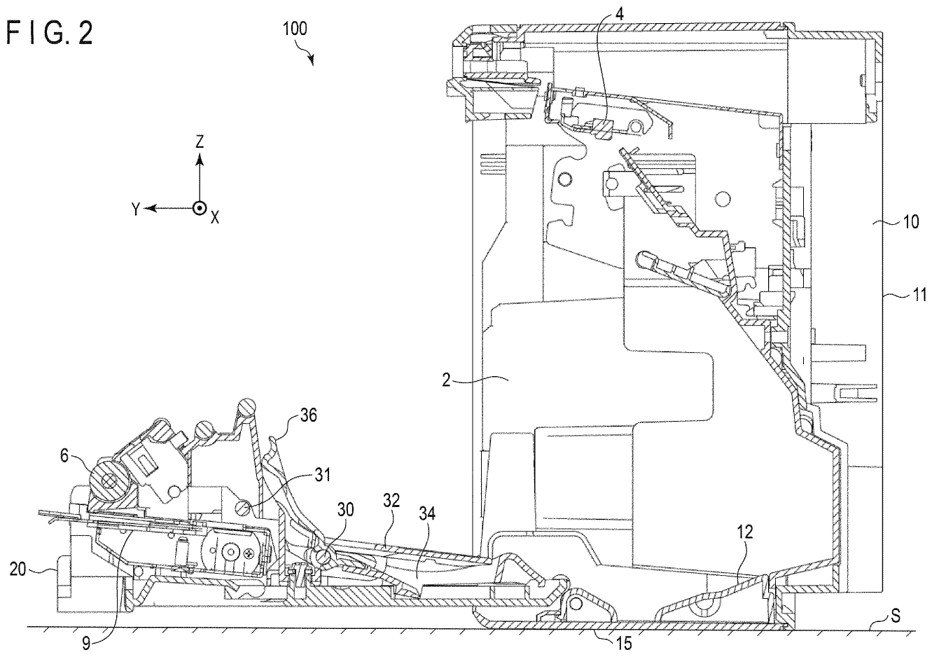

The printer 100 can be used in a vertical posture as shown in FIG. 1. In a state where the printer 100 is arranged in this posture, the hopper 2 of the main body 10 is open on the left side in the drawing, and the cover 20 is located on the left side in the drawing to close the open side of the hopper 2. Therefore, in the case where the cover 20 of the printer 100 placed vertically is rotated about a rotation shaft 21 described later to an open position shown in FIG. 2, the left side of the hopper 2 in the drawing is largely opened, and the cover 20 is in a posture substantially parallel to the installation surface of the printer 100.

In the following description, in a state where the printer 100 is installed vertically as shown in FIG. 1, an open side of the hopper 2, that is, the cover 20 side arranged in a closed position, is referred to as front, and front and rear, up and down, and left and right directions are defined when viewing the printer 100 from the front. In each drawing, a direction from left to right is indicated by an arrow X, a direction from back to front is indicated by an arrow Y, and a direction from bottom to top is indicated by an arrow Z.

The printer 100 can also be used in a horizontal posture (not shown). In this case, the rear surface 11 of the main body 10 is brought into contact with the installation surface, and the front surface of the cover 20 faces upward. In the case where the printer 100 is placed horizontally, the direction of gravity acting on the label roll R and the components of the printer 100 is different by 90°from that in the case of the vertical placement, but the printer 100 operates without any problem as in the case of the vertical placement. Therefore, the following description will be made on the basis of the case where the printer 100 is vertically placed.

In the case where the label roll R is loaded in the printer 100, the cover 20 is opened to the open position where the hopper 2 is opened as shown in FIG. 2, and the label roll R is inserted in a predetermined orientation from the front of the hopper 2. Then, the linerless label L is pulled out from the label roll R and led out from the hopper 2 to outside of the main body 10, and the cover 20 is rotated to the closed position where the hopper 2 is closed. As a result, a tip end of the linerless label L is led out from the discharge port 1 as shown in FIG. 1, and printing on the linerless label L can be performed.

The printer 100 of the present embodiment employs a so-called drop-in method in which the label roll R is loaded into the main body 10 simply by inserting the label roll R into the hopper 2. Therefore, there is no shaft that rotatably supports the label roll R in the hopper 2, and the label roll R is in a movable state in the hopper 2.

The printer 100 includes, at the main body 10 side of the transport path T near the discharge port 1, a print head 4 that functions as a printing part to print information on the linerless label L. The printer 100 includes, at the cover 20 side that faces the print head 4 with the transport path T interposed therebetween, a platen roller 6 that rotates while pressing the linerless label L against the print head 4. The platen roller 6 is driven by a motor (not shown) connected thereto via a drive transmission mechanism (not shown). The platen roller 6 is a component attached to the cover 20 and functions as the conveying part that pulls out the linerless label L from the label roll R and sends the linerless label L from the discharge port 1.

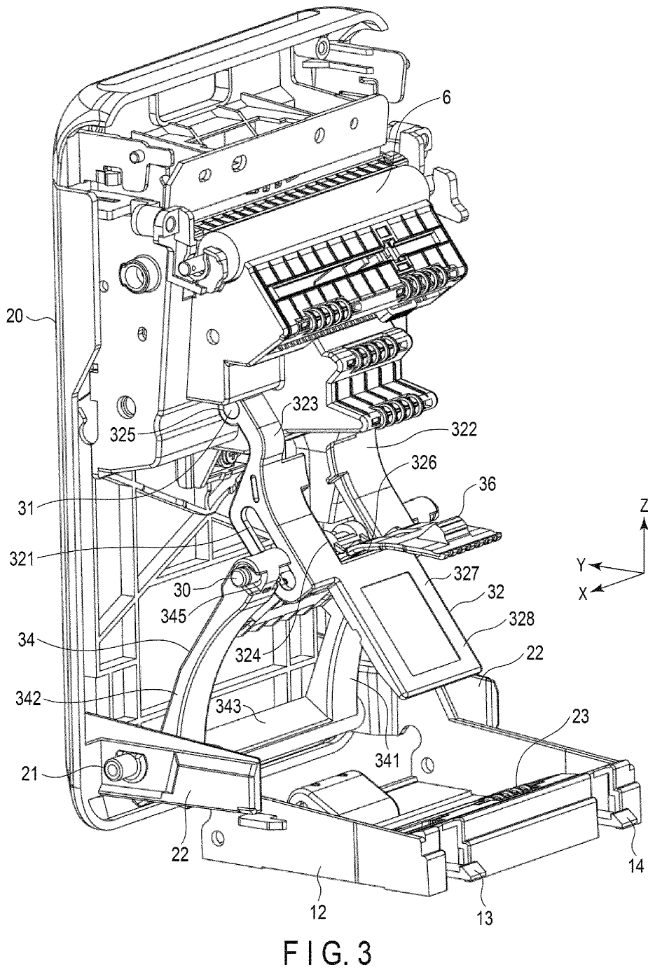

As shown in FIG. 3, the cover 20 integrally includes two rotation shafts 21 extending in a left-right direction. The cover 20 has a pair of left and right projections 22 integrally projecting rearward from the vicinity of the lower end of the cover 20 in the drawing. For example, the right side projection 22 is a plate-like member substantially parallel to the Y-Z plane, and the rotation shaft 21 projects rightward from the right side surface of the right side projection 22. The left side projection 22 has a shape symmetrical to the right side projection 22, and includes the rotation shaft 21 integrally projecting leftward from the left side surface of the left side projection 22. The two right and left rotation shafts 21 are arranged coaxially. In FIG. 3, only the right side rotation shaft 21 is shown, and the left side rotation shaft 21 is not shown. These two rotation shafts 21 function as a third rotation shaft that rotatably connects the vicinity of the lower end 201 of the cover 20 with respect to the main body 10. The cover 20 is rotatable about the two rotation shafts 21 between the closed position shown in FIG. 1 and the open position shown in FIG. 2 with respect to the main body 10. The main body 10 has a bearing (not shown) that rotatably receives the two rotation shafts 21 of the cover 20.

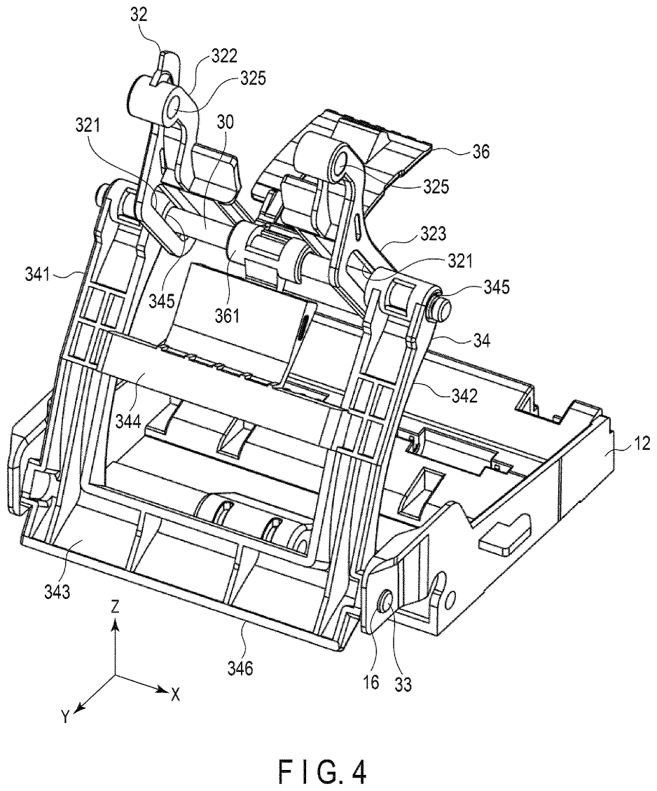

The main body 10 includes a paper guide 12 arranged at the lower side of the hopper 2. The paper guide 12 is incorporated in the main body 10 by two right and left fixing claws 13 and 14 projecting backward. The main body 10 has a flat bottom surface 15 that contacts the installation surface S in a state where the printer 100 is vertically placed. The bottom surface of the paper guide 12 on the hopper 2 side constitutes a part of the inner surface of the hopper 2. The paper guide 12 has near its front end a bearing hole 16 (FIG. 4) for rotatably receiving a rotation shaft 33 of a link arm 34 to be described later.

As shown in FIGS. 3 and 4, the printer 100 includes a flapper 32 attached to the cover 20, the link arm 34 attached to the paper guide 12 of the main body 10, and a holding arm 36. The printer 100 includes a rotation shaft 31 that rotatably attaches a base end (upper end in the drawing) of rotation of the flapper 32 with respect to the cover 20. The printer 100 includes the above-described rotation shaft 33 that rotatably attaches a base end (lower end in the drawing) of rotation of the link arm 34 with respect to the main body 10. The flapper 32 has elongated holes 321 that slidably receive the slide shaft 30 in an intermediate portion in the longitudinal direction away from the rotation shaft 31. The link arm 34 includes the slide shaft 30 that is inserted through and arranged in the elongated holes 321 at a tip end (upper end in the drawing) of rotation at the opposite side to the rotation shaft 33. The holding arm 36 is attached with respect to the slide shaft 30 so as to be freely rotatable.

The rotation shaft 31 of the flapper 32 extends in the left-right direction and functions as a first rotation shaft. A coil spring (not shown) that biases the flapper 32 in the counterclockwise direction in FIG. 3 is attached to the rotation shaft 31. The flapper 32 functions as a pressing member to press the label roll R against the inner surface of the hopper 2 by rotating in the counterclockwise direction in FIG. 3. The rotation shaft 33 of the link arm 34 extends parallel to the rotation shaft 31 and functions as a second rotation shaft. The slide shaft 30 extends in parallel with the rotation shafts 31 and 33, and functions as a slider that is inserted through and arranged in the elongated holes 321 of the flapper 32. The holding arm 36 attached to the slide shaft 30 functions as a restricting member that restricts the movement of the label roll R in the pull-out direction of the linerless label L.

The flapper 32 has two leg portions 322 and 323 that are spaced apart from each other in the left-right direction and are parallel to each other. The two leg portions 322 and 323 each have a bearing hole 325 at the base end of rotation for rotatably receiving the rotation shaft 31. In FIG. 3, only the bearing hole 325 of the right side leg portion 323 is shown, and the left side bearing hole 325 is not shown. As shown in FIG. 4, the two bearing holes 325 are coaxially arranged spaced apart from each other in the left-right direction.

The elongated hole 321 through which the slide shaft 30 is inserted is provided in each of the two leg portions 322 and 323. The two elongated holes 321 have a bilaterally symmetrical shape. The two elongated holes 321 are located at positions spaced apart from the bearing holes 325 toward the tip end side of rotation along the longitudinal direction of the flapper 32. The two elongated holes 321 are provided extending in the longitudinal direction of the flapper 32.

The flapper 32 has a substantially rectangular opening 324 between the two leg portions 322 and 323 at a position spaced apart from the bearing holes 325. The opening 324 is located between the two elongated holes 321. The holding arm 36 is attached to the slide shaft 30 through the opening 324 of the flapper 32. The flapper 32 has, on an edge of the opening 324 at a side far from the bearing holes 325, a locking portion 326 on which a part of the holding arm 36 is abutted to prohibit further rotation of the holding arm 36.

The flapper 32 has a substantially rectangular plate-shaped pressing plate portion 328 having a rectangular frame-shaped flat pressing surface 327 that comes into contact with the label roll R on the tip end side of rotation. The pressing surface 327 of the pressing plate portion 328 is a flat surface facing the hopper 2 of the main body 10. The flapper 32 is rotated in the counterclockwise direction in FIG. 3 by the biasing force of the coil spring provided to the rotation shaft 31, and presses the pressing surface 327 of the pressing plate portion 328 against the outer peripheral surface of the label roll R housed in the hopper 2. Accordingly, the outer peripheral surface of the opposite side of the label roll R is pressed against the inner surface of the hopper 2 on the opposite side to the flapper 32, and the fluttering of the label roll R is suppressed.

The link arm 34 integrally includes a left frame 341, a right frame 342, a coupling frame 343, and an intermediate frame 344. The left frame 341 and the right frame 342 have a bilaterally symmetrical shape, and are spaced apart from each other in the left-right direction and parallel to each other. The coupling frame 343 extends in the left-right direction and couples a base end of rotation of the left frame 341 and a base end of rotation of the right frame 342. The intermediate frame 344 is spaced apart from and extends parallel to the coupling frame 343, and integrally connects an intermediate portion of the left frame 341 and an intermediate portion of the right frame 342.

A tip end of rotation of the left frame 341 spaced apart from the coupling frame 343 and a tip end of rotation of the right frame 342 spaced apart from the coupling frame 343 are respectively provided with the bearing hole 345 for rotatably receiving the slide shaft 30. The link arm 34 has two bearing holes 345 coaxially. The left side rotation shaft 33 of the link arm 34 protrudes leftward from the left side surface of the left frame 341 near the base end of the left frame 341. The right side rotation shaft 33 of the link arm 34 protrudes rightward from the right side surface of the right frame 342 near the base end of the right frame 342.

The slide shaft 30 is inserted through and arranged in the two elongated holes 321 of the flapper 32 and the two bearing holes 345 of the link arm 34, thus forming a link mechanism. As shown in FIG. 4, the link arm 34 will be positioned between the rotation shaft 33 shaft and the slide shaft 30. The flapper 32 is biased in the counterclockwise direction in FIG. 3 by a coil spring provided to the rotation shaft 31, and this biasing force is transmitted to the link arm 34 via the slide shaft 30 and the elongated holes 321. The link mechanism limits the swing range of the flapper 32.

The holding arm 36 is formed in a substantially rectangular plate shape slightly curved along the outer periphery of the label roll R, and integrally has a coupling portion 361 rotatably coupled to the slide shaft 30 at the base end of rotation of the holding arm 36. The coupling portion 361 has a structure that can be coupled to the slide shaft 30 from the pressing surface 327 side of the flapper 32 via the opening 324 of the flapper 32. The holding arm 36 is freely rotatable with respect to the slide shaft 30. The inside of the curve of the holding arm 36 faces the pressing surface 327 of the pressing plate portion 328 of the flapper 32. FIG. 3 shows a state in which the rotation of the holding arm 36 in the clockwise direction by its own weight is stopped by the locking portion 326 of the flapper 32.

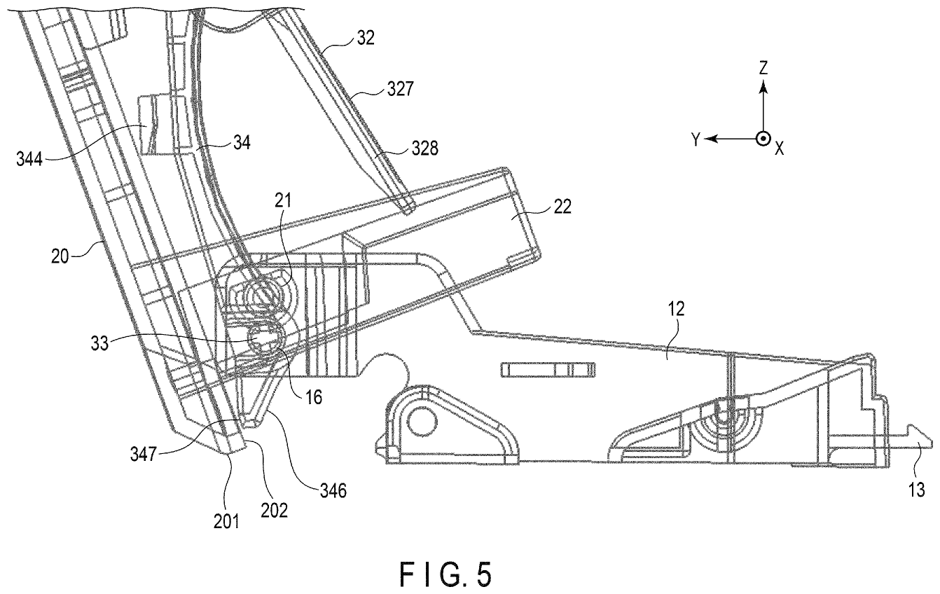

As shown in FIG. 5, the rotation shaft 21 projecting outward from the projection 22 near the lower end of the cover 20 is slightly displaced upward from the rotation shaft 33 of the link arm 34 inserted through the bearing hole 16 provided near the front end of the paper guide 12 of the main body 10. The lower end 346 of the link arm 34 at the opposite side to the slide shaft 30 with respect to the rotation shaft 33 has a pressed surface 347 that is close to and faces the inner surface 202 of the lower end 201 of the cover 20 that is spaced apart from the rotation shaft 21. The lower end 346 of the link arm 34 functions as a protruding portion pressed by the inner surface 202 of the cover 20, and the inner surface 202 near the lower end 201 of the cover 20 functions as a pressing portion to press the pressed surface 347 of the lower end 346 of the link arm 34.

In the case where the cover 20 arranged at the closed position shown in FIG. 1 is rotated counterclockwise about the rotation shaft 21 toward the open position shown in FIG. 2, the lower end 201 of the cover 20 is rotated counterclockwise in FIG. 5 about the rotation shaft 21. Then, the inner surface 202 near the lower end 201 of the cover 20 presses the pressed surface 347 of the lower end 346 of the link arm 34. As a result, the link arm 34 is rotated counterclockwise about the rotation shaft 33 against the biasing force of the coil spring provided to the rotation shaft 31 of the flapper 32, and is housed in a state of approaching the inner surface of the cover 20 as illustrated in FIG. 2. At this time, the flapper 32 is rotated clockwise about the rotation shaft 31 by the link mechanism and is housed inside the cover 20, and thus the label roll R may be easily inserted into the hopper 2 (FIG. 2).

In the case where the cover 20 is rotated in the clockwise direction about the rotation shaft 21 from the open position illustrated in FIG. 2 toward the closed position illustrated in FIG. 1, the lower end 201 of the cover 20 is rotated in the clockwise direction about the rotation shaft 21 away from the pressed surface 347 of the link arm 34, and the flapper 32 is rotated in the counterclockwise direction about the rotation shaft 31 by the biasing force of the coil spring. At this time, the link arm 34 rotates in the clockwise direction about the rotation shaft 33. This state is shown in FIG. 3.

In the case where the cover 20 is closed to the closed position shown in FIG. 1 after the cover 20 is opened and an unused label roll R is inserted into the hopper 2, the flapper 32 is biased in the counterclockwise direction by the coil spring, and the pressing surface 327 of the flapper 32 presses the outer peripheral surface of the label roll R. In this state, the holding arm 36 attached to the slide shaft 30 comes into contact with the outer peripheral surface of the label roll R by its own weight. Immediately after the unused label roll R is inserted into the hopper 2, the outer peripheral surface of the label roll R is in contact with the plurality of guide rolls 23 provided on the inner surface of the hopper 2.

Therefore, even when the linerless label L is pulled out from the label roll R by the rotation of the platen roller 6 and the label roll R is rotated, the label roll R is less likely to become unstable in the hopper 2. That is, the label roll R is sandwiched between the pressing surface 327 of the flapper 32 and the inner surface of the hopper 2 on the opposite side (in this case, the outer peripheral surface of the guide rolls 23), and an issue wherein the label roll R becomes unstable in the hopper 2 can be suppressed.

Further, since the holding arm 36 is in contact with the outer peripheral surface of the label roll R by its own weight, even if the label roll R moves in the pulling out direction of the linerless label L due to the pulling out of the linerless label L, it is possible to prevent an issue wherein the outer peripheral surface of the label roll R collides with the cover 20 or the main body 10. In this way, by preventing the collision of the label roll R by the holding arm 36, it is possible to suppress the undesired vibration generated in the printer 100 due to the collision, and it is possible to prevent an issue wherein the vibration is transmitted to the print head 4. As a result, the print head 4 does not vibrate, the conveyance position of the linerless label L is not displaced, and high-quality printing can be performed.

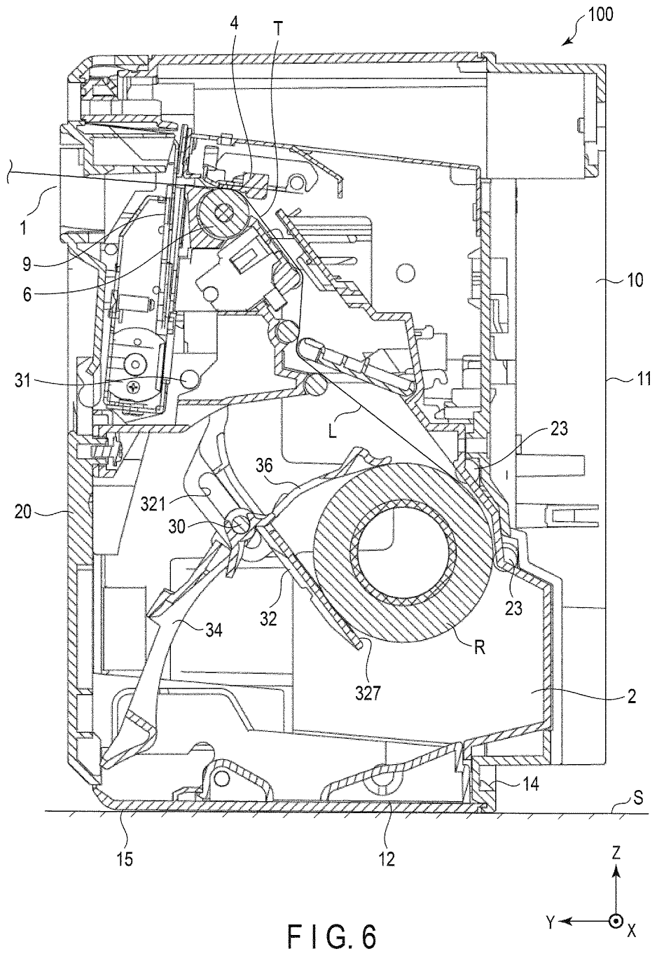

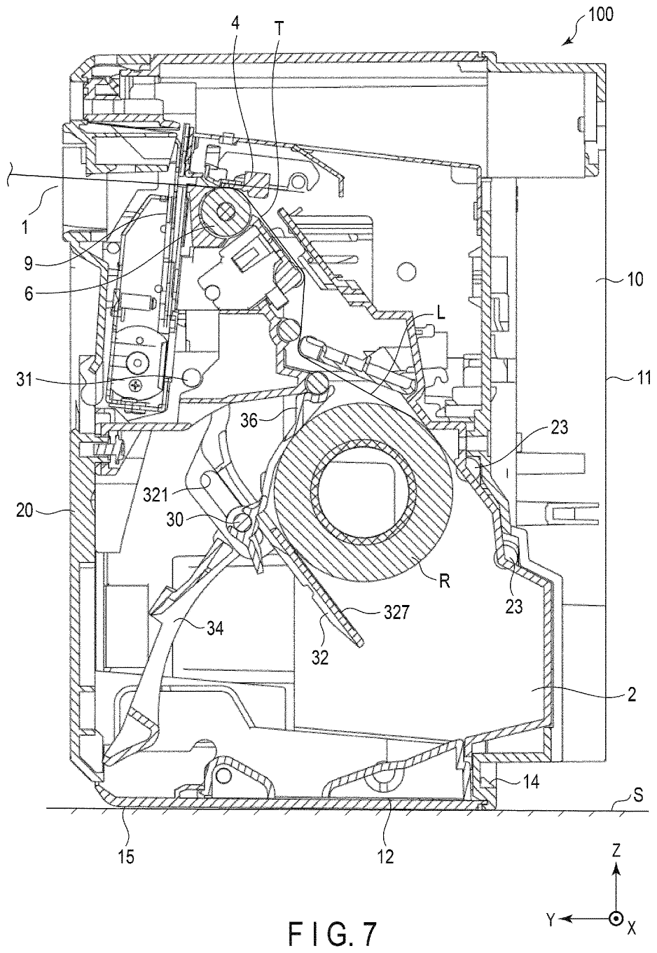

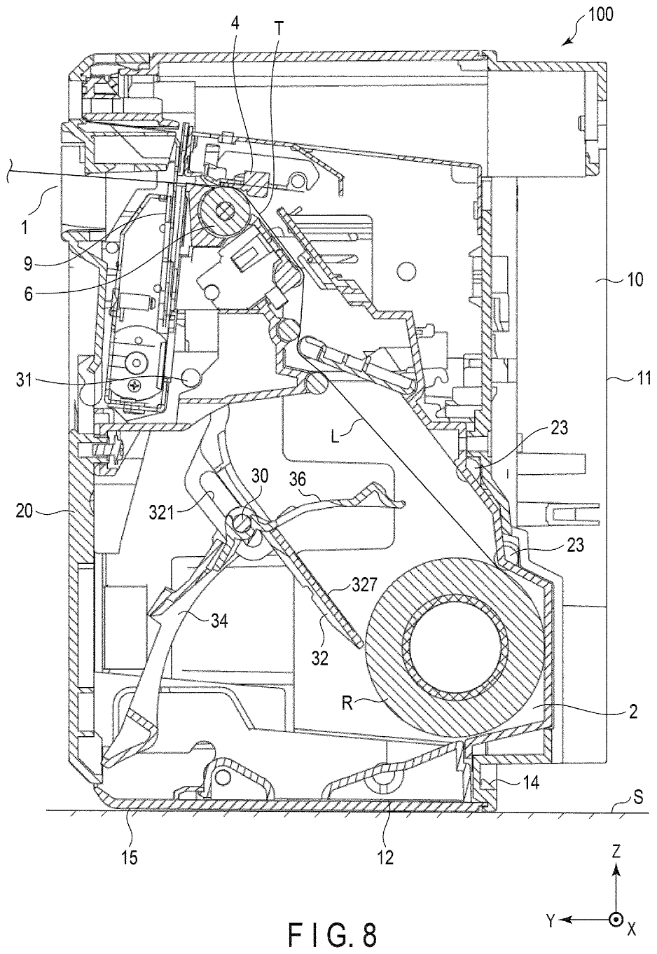

In the case where the linerless label L is pulled out and the diameter of the label roll R is reduced to the extent shown in FIG. 6, for example, the label roll R can be moved to the position shown in FIG. 7 where the label roll R is moved in the direction in which the linerless label L is pulled out or the position shown in FIG. 8 where the label roll R is moved to the bottom of the hopper 2. In the case where the small-diameter label roll R is located at the intermediate position shown in FIG. 6, the flapper 32 presses the label roll R against the inner surface of the hopper 2 with the pressing surface 327, and the holding arm 36 contacts the outer peripheral surface of the linerless label L by its own weight, as in the case of the unused label roll R described above.

In the case where the linerless label L is pulled out and the label roll R is pulled up to the position shown in FIG. 7, the flapper 32 presses the label roll R against the inner surface of the hopper 2 with the pressing surface 327, and the holding arm 36 restricts further upward movement of the label roll R to prevent an issue wherein the label roll R collides with the components of the cover 20. Accordingly, it is possible to suppress an issue wherein vibration occurs due to the collision of the label roll R in the print head 4 or the platen roller 6, and thus it is possible to perform printing with a high quality.

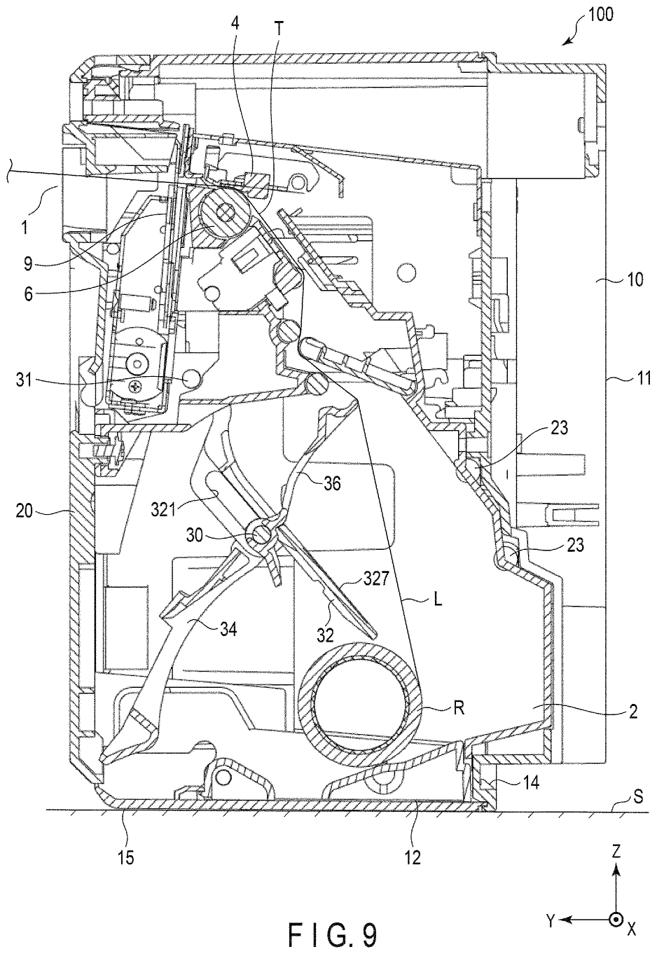

In the case where the diameter of the label roll R is further reduced by the pulling out of the linerless label L, the label roll R passes through between the tip end of rotation of the flapper 32 and the bottom surface of the hopper 2 as illustrated in FIG. 9. The label roll R that has moved to this position does not pass through the tip end of the flapper 32 again, and stays at this position. Therefore, the label roll R does not move upward until the linerless label L is used up, and does not collide with the components of the cover 20, the frame of the main body 10, or the like. By the holding arm 36 being positioned on the path of the linerless label L, the holding arm 36 serves as a damper to reduce a load applied to the linerless label L. Therefore, the label roll R does not move upward.

As described above, according to the present embodiment, the label roll R inserted into the hopper 2 is pressed against the inner surface of the hopper 2 by the flapper 32, and thus an issue wherein the label roll R becomes unstable in the hopper 2 can be suppressed. Further, since the holding arm 36 is brought into contact with the outer peripheral surface of the label roll R by its own weight from the downstream side of the linerless label L in the pulling out direction, it is possible to prevent an issue wherein the label roll R collides with the components at the cover side or collides with the frame of the main body 10. Therefore, the printer 100 of the present embodiment can print with a high quality.

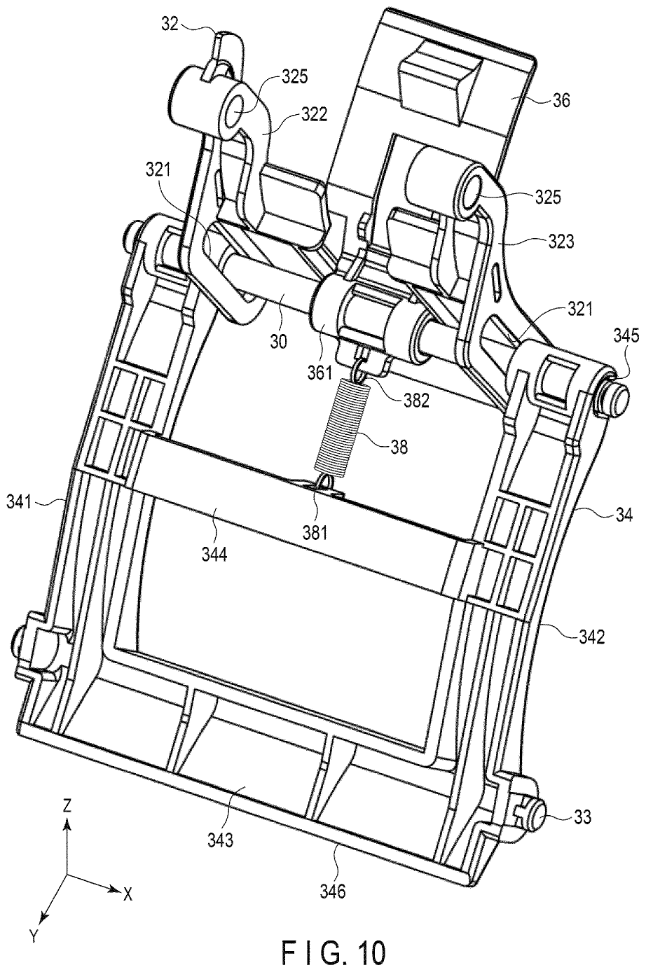

Hereinafter, a modification in which a tension spring 38 is attached between the link arm 34 and the holding arm 36 will be described with reference to FIG. 10. The printer according to the modification has substantially the same structure as the printer 100 of the above-described embodiment except that the tension spring 38 is provided. Therefore, only portions different from the above-described embodiment will be described in detail.

The tension spring 38 is fixed, in a slightly stretched state, at one end 381 to the slide shaft 30 side at the center in the left-right direction of the intermediate frame 344 of the link arm 34 and at the other end 382 to the coupling portion 361 of the holding arm 36. The tension spring 38 functions to hold the holding arm 36 at a position where the longitudinal direction of the link arm 34 and the longitudinal direction of the holding arm 36 are arranged substantially in a straight line. A plurality of the tension springs 38 may be attached.

For example, in a case where an unused label roll R is inserted into the printer as illustrated in FIG. 1, if the holding arm 36 is biased in the clockwise direction, a pressing force in a direction that becomes a load with respect to the rotation direction (counterclockwise direction) of the label roll R is applied to the outer peripheral surface of the label roll R at the time the linerless label L is pulled out, and it becomes difficult for the label roll R to rotate. For example, in the case where the holding arm 36 is biased in the counterclockwise direction in a state where the diameter of the label roll R is reduced and the label roll R is arranged at the position illustrated in FIG. 6, the tip end of rotation of the holding arm 36 is in a state of being always pressed against the components at the cover 20 side, and the link arm 34 tries to rotate in the clockwise direction with the tip end of the holding arm 36 as a fulcrum. In this case, a force in a direction in which the pressing surface 327 of the flapper 32 presses the outer peripheral surface of the label roll R acts, and the rotation of the label roll R is braked.

Therefore, as in the present modification, it is effective to hold the holding arm 36 in a straight line with the link arm 34, and thus the linerless label L can be normally pulled out from the label roll R, and high-quality printing is possible.

While certain embodiments of the present invention have been described, these embodiments have been presented by way of example only, and are not intended to limit the scope of the inventions. These novel embodiments may be embodied in a variety of other forms, and various omissions, substitutions, and changes in the form of the embodiments described herein may be made without departing from the spirit of the inventions. These embodiments and their modifications are covered by the accompanying claims and their equivalents, as would fall within the scope and the gist of the claimed inventions.

The above-described embodiments may be expressed as follows.

(1) A printer, comprising:
a main body including a housing portion to house a roll of a long printing medium wound in a roll shape;
a cover to open and close the housing portion;
a conveying part to pull out the printing medium from the roll and send the printing medium to outside of the main body;
a printing part to print information on the printing medium pulled out from the roll by the conveying part;
a pressing member rotatably attached to the cover via a first rotation shaft and press the roll against an inner surface of the housing portion;
a link arm rotatably attached to the main body via a second rotation shaft parallel to the first rotation shaft, the link arm including a slider slidably inserted through and arranged in an elongated hole in the pressing member; and
a restricting member attached to the slider and configured to restrict movement of the roll in a direction in which the printing medium is pulled out.

(2) The printer according to (1), wherein
the slider is a slide shaft parallel to the first rotation shaft and the second rotation shaft, and
the restricting member is rotatably attached to the slide shaft.

(3) The printer according to (2), wherein
the restricting member rotates about the slide shaft by its own weight and can come into contact with the roll, and
the pressing member includes a locking portion to engage with the restricting member during rotation of the restricting member by its own weight and prohibit further rotation of the restricting member.

(4) The printer according to (2), further including a tension spring stretched between the link arm and the restricting member between the second rotation shaft and the slide shaft.

(5) The printer according to (1), wherein
the cover is rotatably attached to the main body via a third rotation shaft spaced apart from and in parallel to the second rotation shaft, the cover including a pressing portion to press, by means of rotation from a closed position where the housing portion is closed to an open position where the housing portion is opened, a protruding portion of the link arm that is located on an opposite side to the slider with respect to the second rotation shaft so as to rotate the link arm in a direction approaching the cover.

What is claimed is:

1. A printer comprising:
a main body including a housing portion to house a roll of a long printing medium wound in a roll shape;
a cover to open and close the housing portion;
a conveying part configured to pull out the printing medium from the roll and send the printing medium to outside of the main body;
a printing part configured to print information on the printing medium pulled out from the roll by the conveying part;
a pressing member rotatably attached to the cover via a first rotation shaft and configured to press the roll against an inner surface of the housing portion;
a link arm rotatably attached to the main body via a second rotation shaft parallel to the first rotation shaft, the link arm including a slider slidably inserted through and arranged in an elongated hole in the pressing member; and
a restricting member attached to the slider and configured to restrict movement of the roll in a direction in which the printing medium is pulled out.

2. The printer according to claim 1, wherein
the slider is a slide shaft parallel to the first rotation shaft and the second rotation shaft, and
the restricting member is rotatably attached to the slide shaft.

3. The printer according to claim 2, wherein
the restricting member is configured to rotate about the slide shaft by its own weight and can come into contact with the roll, and
the pressing member includes a locking portion configured to engage with the restricting member during rotation of the restricting member by its own weight and prohibit further rotation of the restricting member.

4. The printer according to claim 2, further comprising a tension spring stretched between the link arm and the restricting member, the link arm between the second rotation shaft and the slide shaft.

5. The printer according to claim 4, wherein the tension spring is stretched between an intermediate frame of the link arm and a coupling portion of the restricting member.

6. The printer according to claim 1, wherein
the cover is rotatably attached to the main body via a third rotation shaft spaced apart from and in parallel to the second rotation shaft, the cover including a pressing portion configured to press, by means of rotation from a closed position where the housing portion is closed to an open position where the housing portion is opened, a protruding portion of the link arm that is located on an opposite side to the slider with respect to the second rotation shaft so as to rotate the link arm in a direction approaching the cover.
